(19) United States
(12) Patent Application Publication
(10) Pub. No.: US 2026/0203366 A1
(43) Pub. Date: Jul. 16, 2026

(54) COMPUTING INVERSE DATA STRUCTURE APPROXIMATIONS USING A REGENERATIVE MARKOV CHAIN MONTE CARLO TECHNIQUE

(71) Applicant: International Business Machines Corporation, Armonk, NY (US)

(72) Inventors: Soumyadip GHOSH, PeekSkill, NY (US); Lior HORESH, North Salem, NY (US); Vasileios KALANTZIS, Nyack, NY (US); Yingdong LU, Yorktown Heights, NY (US); Tomasz J. NOWICKI, Fort Montgomery, NY (US)

(21) Appl. No.: 19/022,719

(22) Filed: Jan. 15, 2025

(51) Int. Cl. G06F 17/15

(52) U.S. Cl. CPC G06F 17/15

(57) ABSTRACT

A processor set may generate, using a Markov chain Monte Carlo (MCMC) process, a sequence of states of a data structure and weights for transitions between states in the sequence of states. The processor set may generate a covariance data structure of the data structure based on the sequence of states and the associated weights. The processor set may determine, using a regenerative structure of the MCMC process, an estimator for an approximated inverse of the covariance data structure. The regenerative structure of the MCMC process is based on a non-truncated Neumann series of the covariance data structure. The processor set may generate a precision data structure based on the estimator. The precision data structure corresponds to the approximated inverse of the covariance data structure. The processor set may determine, based on the precision data structure, a partial correlation between two or more data points in the data structure.

### BACKGROUND

The following disclosure is submitted under 35 U.S.C. 102(b)(1)(A):

DISCLOSURE: “Regenerative Ulam-von Neumann Algorithm: An Innovative Markov chain Monte Carlo Method for Matrix Inversion,” Soumyadip Ghosh, Lior Horesh, Vassilis Kalantzis, Yingdong Liu, Tomasz Nowicki, page 1-26, published at arXiv.org on Jul. 23, 2024, available at https://arxiv.org/pdf/2407.16661v1.

### BACKGROUND

This disclosure relates to computing systems, and more specifically, to computing inverse data structure approximations using a regenerative Markov chain Monte Carlo technique.

### SUMMARY

Some implementations described herein relate to a computer-implemented method. The computer-implemented method may include generating, by the processor set, a covariance data structure from a plurality of data points. The computer-implemented method may include determining, by the processor set and using a regenerative structure of a Markov chain Monte Carlo (MCMC) process, an estimator for an approximated inverse of the covariance data structure. The regenerative structure of the MCMC process is based on a non-truncated Neumann series of the covariance data structure. The computer-implemented method may include generating, by the processor set, a precision data structure based on the estimator. The precision data structure corresponds to the approximated inverse of the covariance data structure. The computer-implemented method may include determining, by the processor set based on the precision data structure, a partial correlation between two or more data points in the covariance data structure.

Some implementations described herein relate to a computer system. The computer system may include a processor set, one or more computer-readable storage media, and program instructions stored on the one or more computer-readable storage media to cause the processor set to perform operations. The operations include receiving a data structure. The operations include generating a Markov chain transition from a first state to a second state of the data structure and an associated probability of the Markov chain transition. The operations include updating, based on the Markov chain transition and the associated probability, a current weight data structure, a cumulative weight data structure, and a regenerative cycle count data structure. The operations include generating an inverse data structure based on the current weight data structure, the cumulative weight data structure, and the regenerative cycle count data structure after updating the current weight data structure, the cumulative weight data structure, and the regenerative cycle count data structure. The operations include determining a partial correlation between two or more data points in the data structure.

Some implementations described herein relate to a computer program product. The computer program product may include one or more computer-readable storage media and program instructions stored on the one or more computer-readable storage media to perform operations. The operations include receiving a data structure. The operations include generating, using an MCMC process, a Markov chain transition from a first state to a second state of the data structure and an associated probability. The operations include identifying a regenerative structure of the MCMC process. The operations include determining, using the regenerative structure of the MCMC process, an estimator for determining an approximated inverse data structure of the data structure. The operations include generating, using the estimator, the approximated inverse data structure of the data structure. The processor may be configured to determining a partial correlation between two or more data points in the data structure.

### BRIEF DESCRIPTION OF THE DRAWINGS

FIG. 1 is a diagram of an example computing environment for computing inverse data structure approximations using a regenerative Markov chain Monte Carlo (MCMC) technique described herein.

FIGS. 2A-2F are diagrams of an example implementation of computing inverse data structure approximations using a regenerative MCMC technique described herein.

FIG. 3 is a diagram of an example implementation of determining connections between network entities in a computer network based on an inverse data structure approximation that as determined using a regenerative MCMC technique described herein.

FIG. 4 is a diagram of example components of a device associated with computing inverse data structure approximations using a regenerative Markov chain Monte Carlo technique.

FIG. 5 is a flowchart of an example process associated with computing inverse data structure approximations using a regenerative MCMC technique.

FIG. 6 is a flowchart of an example process associated with computing inverse data structure approximations using a regenerative MCMC technique.

FIG. 7 is a flowchart of an example process associated with computing inverse data structure approximations using a regenerative MCMC technique.

### DETAILED DESCRIPTION

The following detailed description of example implementations refers to the accompanying drawings. The same reference numbers in different drawings may identify the same or similar elements.

Matrix inversion is a technique that is used in linear computing systems, with numerous applications in various fields such as data analytics, machine learning, and scientific computing. Matrix inversion of a data structure can be used to infer relationships between random and/or pseudorandom traditional data points. However, some methods for matrix inversion, such as Gaussian elimination or LU (lower matrix and upper matrix) decomposition, can be computationally intensive and may not be suitable for large-scale data structures, such as those associated with entities that communicate over computer networks and/or those associated with complex artificial intelligence models.

The Ulam-von Neumann algorithm is a Markov chain Monte Carlo (MCMC) method that can be used for estimating the inverse of a data structure. The Ulam-von Neumann algorithm involves constructing and sampling a discrete Markov chain with a state space defined by the rows of an iteration data structure and a transition probability data structure. The samples are used to estimate a truncation of a Neumann series, and the probabilities of Markov chain transits between states stored in the transition probability data structure can be estimated by Monte-Carlo simulations of the Markov chain. These simulations can be used to estimate the inverse of the data structure via the Neumann series.

The Ulam-von Neumann algorithm can be appealing in a variety of computing applications due to high parallel granularity and the ability to compute partial solutions of linear systems. However, the truncation of the Neumann series can introduce bias into the estimation of the inverse of the data structure. This bias can lead to reduced accuracy in inferences generated for the data points of the data structure based on the inverse of the data structure. For example, the bias introduced from the truncation of the Neumann series can lead to reduced accuracy in inferring relationships between data points, in identifying data points of influence in the data structure (e.g., network entities of influence in a computer network), and/or in inferences generated using an artificial intelligence/machine learning model.

On the other hand, increasing the truncation order of the Neumann series (e.g., increasing the length of cycles of the discrete Markov chain) may increase the accuracy of inferences generated based on the inverse of the data structure. However, each additional sample or cycle increases the consumption of processing resources, memory resources, power resources, and/or networking resources of the computing system that performs the data structure inversion.

In some implementations described herein, data structure inversion is performed by a computing system using a regenerative Ulam-von Neumann process. The regenerative Ulam-von Neumann process utilizes the regenerative structure of the Neumann series defined by a non-singular matrix and produces an unbiased estimator of the inversion of the data structure. The estimator is unbiased in that the estimator is determined without truncating the Neumann series. Thus, the accuracy of the estimator that is used for performing the inversion of the data structure is dependent on only a single parameter, which is the total quantity of Markov transitions that is simulated. As such, the inversion of the data structure (and the inferences generated based on the inversion of the data structure) can be generated with high accuracy with fewer samples or cycles than other techniques, thereby reducing consumption of processing resources, memory resources, power resources, and/or networking resources of the computing system for performing the data structure inversion. The cycles can be processed in parallel by parallel processing hardware (e.g., artificial intelligence accelerators, graphics processing units), which further increases the scalability and efficiency for determining the estimator).

In this way, the techniques described herein provide an unbiased estimator for data set inversion that reduces the computational complexity associated with other techniques, thereby conserving processing resources, memory resources, network resources, and/or the like. Additionally, the techniques described herein may reduce the number of iterations for achieving a particular level of accuracy, resulting in further conservation of computing resources. The techniques described herein may also minimize the impact of numerical instability and/or round-off errors on the accuracy of the estimator, resulting in a more robust and reliable data set inversion. The increased accuracy and reduced power consumption achieved by using the regenerative structure of the Neumann series to determine the estimator may enable computers to perform highly complex computational operations more accurately and more power efficiently, such as preconditioning (e.g., constructing a preconditioner for sparse/dense linear systems), trace/diagonal estimation (e.g., estimating the trace/diagonal of a matrix inverse for data analytics and/or network analytics), and/or Katz centralities, among other examples.

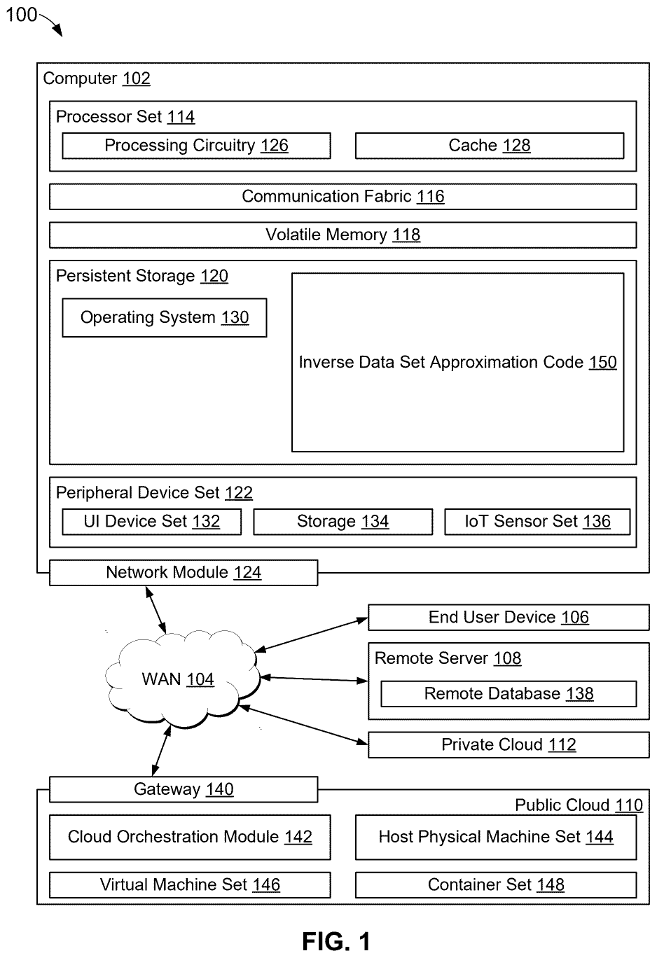

FIG. 1 is a diagram of an example computing environment 100 for computing inverse data structure approximations using a regenerative MCMC technique described herein.

Computing environment 100 contains an example of an environment for the execution of at least some of the computer code involved in performing the inventive methods, such as inverse data set approximation code 150. In addition to inverse data set approximation code 150, computing environment 100 includes, for example, computer 102, wide area network (WAN) 104, end user device (EUD) 106, remote server 108, public cloud 110, and private cloud 112. In this embodiment, computer 102 includes processor set 114 (including processing circuitry 126 and cache 128), communication fabric 116, volatile memory 118, persistent storage 120 (including operating system 130 and inverse data set approximation code 150, as identified above), peripheral device set 122 (including user interface (UI) device set 132, storage 134, and Internet of Things (IoT) sensor set 136), and network module 124. Remote server 108 includes remote database 138. Public cloud 110 includes gateway 140, cloud orchestration module 142, host physical machine set 144, virtual machine set 146, and container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one, or more, computer processors of any type now known or to be developed in the future. Processing circuitry 126 may be distributed over multiple packages, for example, multiple, coordinated integrated circuit chips. Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in inverse data set approximation code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data and re-writing of data. Some familiar forms of persistent storage include magnetic disks and solid state storage devices. Operating system 130 may take several forms, such as various known proprietary operating systems or open source Portable Operating System Interface-type operating systems that employ a kernel.

The code included in inverse data set approximation code 150 typically includes at least some of the computer code involved in performing the inventive methods. The operations may include, for example, generating a covariance data structure from a plurality of data points; determining, by the processor set and using a regenerative structure of an MCMC process, an estimator for an approximated inverse of the covariance data structure, where the regenerative structure of the MCMC process is based on a non-truncated Neumann series of the covariance data structure; generating a precision data structure based on the estimator, where the precision data structure corresponds to the approximated inverse of the covariance data structure; and/or determining, based on the precision data structure, a partial correlation between two or more data points in the covariance data structure.

The operations may include, for example, receiving a data structure; generating, using an MCMC process, a Markov chain transition from a first state to a second state of the data structure and an associated probability; identifying a regenerative structure of the MCMC process; determining, using the regenerative structure of the MCMC process, an estimator for determining an approximated inverse data structure of the data structure; generating, using the estimator, the approximated inverse data structure of the data structure; and/or determining a partial correlation between two or more data points in the data structure.

The operations may include, for example, receiving a data structure; generating, using a an MCMC process, a Markov chain transition from a first state to a second state of the data structure and an associated probability; identifying a regenerative structure of the MCMC process; determining, using the regenerative structure of the MCMC process, an estimator for determining an approximated inverse data structure of the data structure; generating, using the estimator, the approximated inverse data structure of the data structure; and/or determining a partial correlation between two or more data points in the data structure.

Peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 132 may include components such as a display screen, speaker, microphone, wearable devices (such as goggles and smart watches), keyboard, mouse, printer, touchpad, game controllers, and haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, then this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. It is understood that these VCEs may be stored as images and may be transferred among and between the various physical machine hosts, either as images or after instantiation of the VCE. Cloud orchestration module 142 manages the transfer and storage of images, deploys new instantiations of VCEs and manages active instantiations of VCE deployments. Gateway 140 is the collection of computer software, hardware, and firmware that allows public cloud 110 to communicate through WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

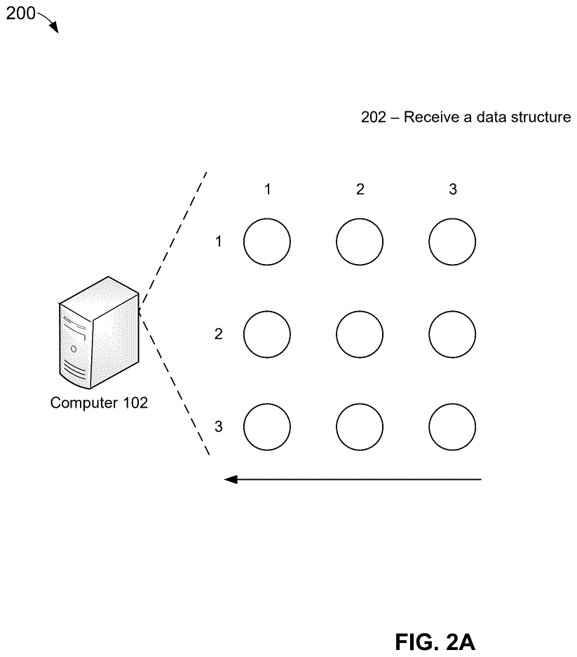

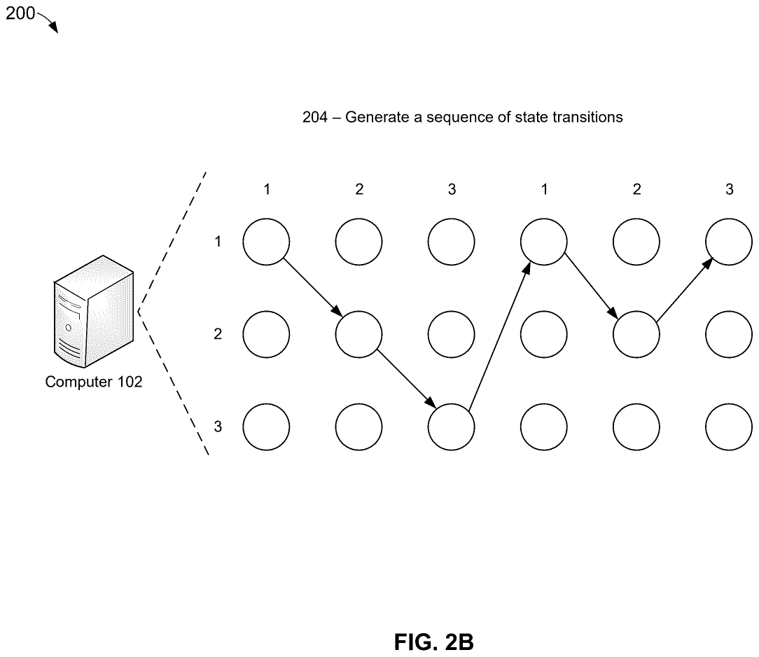

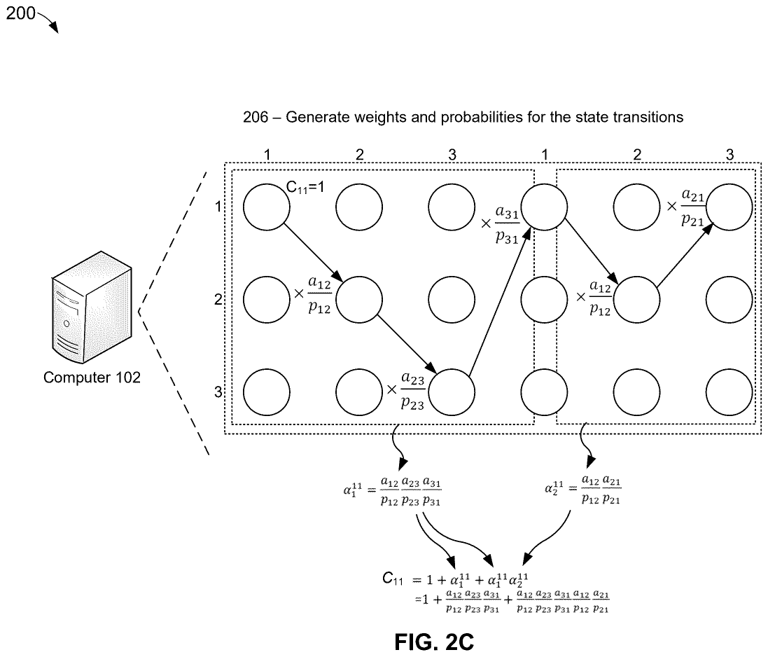

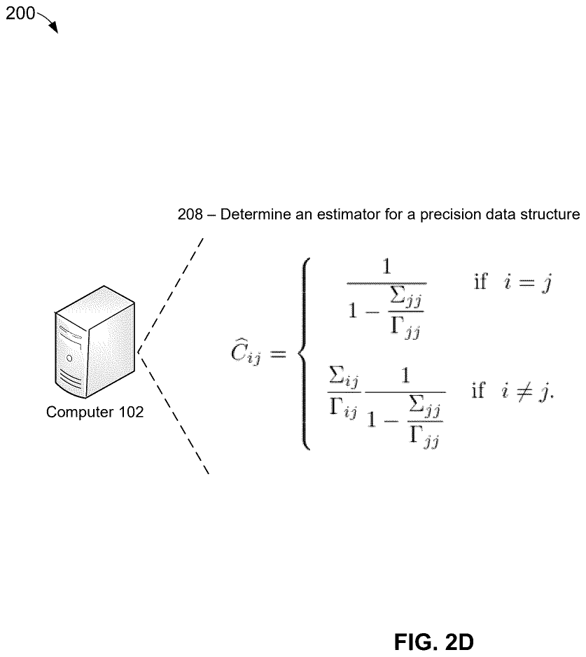

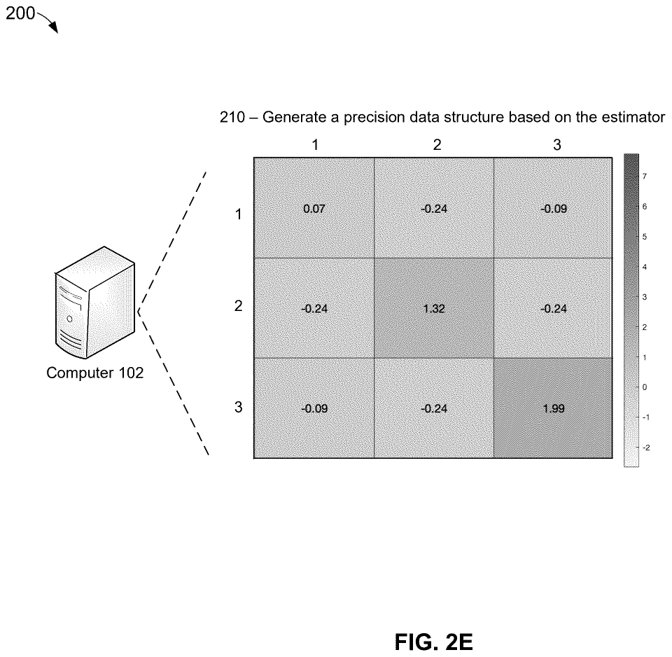

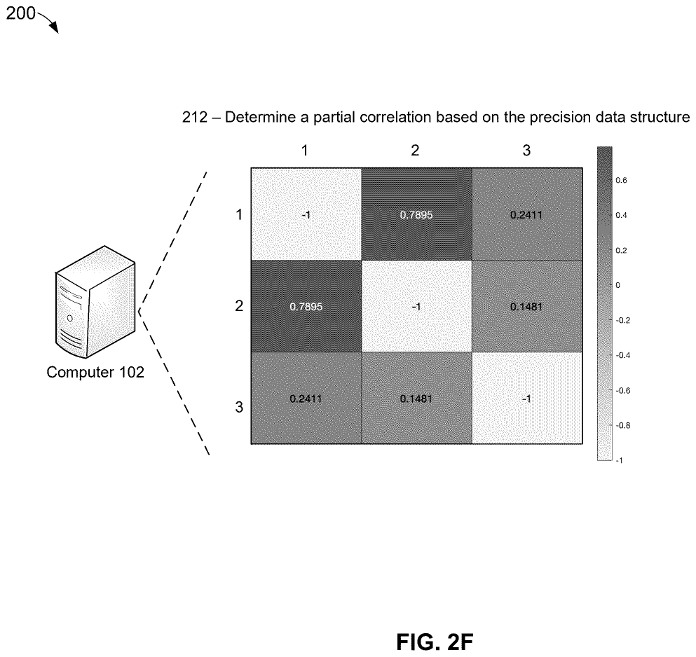

FIGS. 2A-2F are diagrams of an example implementation 200 of computing inverse data structure approximations using a regenerative MCMC technique described herein. One or more operations illustrated and described in connection with FIGS. 2A-2F may be performed by an entity of computing environment 100, such as computer 102. In some implementations, one or more operations illustrated and described in connection with FIGS. 2A-2F may be performed by another entity of computing environment 100, such as EUD 106, remote server 108, public cloud 110, and/or private cloud 112, among other examples. In some implementations, computer 102 may execute inverse data set approximation code 150 to perform one or more of the operations described in the example implementation 200.

As shown in FIG. 2A, and by reference number 202, computer 102 (e.g., processor set 114 of computer 102) may receive a data structure. The data structure may be a matrix data structure (e.g., a d×d matrix structure A, such as a 3×3 matrix structure illustrated in the example in FIG. 2A) that includes a plurality of data points that are arranged in a plurality of rows and a plurality of columns. The matrix is non-singular, meaning that an inverse can be computed. The data points may be associated with various types of data, such as network entity identifiers, identifiers associated with users of EUDs 106, connections between users, machine learning model parameters, machine learning model outputs, and/or other types of data.

The data structure is stored in one or more locations on computer 102, such as volatile memory 118, persistent storage 120, cache 128, and/or storage 134, among other examples. Computer 102 may receive the data structure as an entire completed data set of data points, or may receive the data structure in discrete portions that each contain a subset of the data points of the data structure. Computer 102 may receive the data structure from another entity in computing environment 100, such as one or more EUDs 106, remote server 108, public cloud 110, and/or private cloud 112, among other examples.

In some implementations, computer 102 uses the data points of the data structure to generate a covariance data structure that represents the variance of the data points in the data structure, and the covariance between random data points in the data structure. Computer 102 may generate the covariance data structure by generating an n×n matrix structure (e.g., a square matrix structure) such that diagonal elements of the n×n matrix structure represent the variances of the data points, and the off-diagonal elements represent the covariances between data points.

$$\sum = Cov ( X ) = E [ ( X - μ ) ( X - μ ) T ] ,$$

where E[⋅] is the expectation operator, u is the mean vector of X, and Σ is an n×n matrix structure where each element o_{L}; represents the covariance between the random variables Xᵢ and Xⱼ.

Computer 102 may generate the covariance data structure based on an identity data structure (e.g., an identity matrix (I)) associated with the covariance data structure). For example, computer 102 may set the covariance data structure (e.g., a covariance matrix (A)) to:

$$A = I - A ,$$

where the inverse of the covariance data structure can be represented as:

$$C = {( I - A )}^{- 1} .$$

As shown in FIG. 2B, and by reference number 204, computer 102 (e.g., processor set 114 of computer 102) may generate a sequence of transitions between data points in the data structure (or in the covariance data structure). The sequence of transitions may correspond to a plurality of Markov chain transitions between the data points. For example, a Markov chain transition may correspond to a transition from a first state (e.g., a first data point at state 1) to a second state (e.g., a second data point at state 2) of a data structure and an associated probability of the Markov chain transition.

Computer 102 may generate the sequence of transitions using an MCMC process. The MCMC process may include constructing and sampling a discrete Markov chain with a state space defined by the rows of an iteration data structure (e.g., an identity matrix (I)) and a transition probability data structure (e.g., a probability matrix (P)) associated with the covariance data structure.

As shown in FIG. 2B, in some implementations, computer 102 may generate a plurality of replicates of the Markov chain, indexed by n=1, . . . , N. For example, a first replicate may include a transition sequence of State 1 (S₁)→State 2 (S₂)→State 3 (S₃). The state transition may return to C₁₁ for a second replicate that may include a transition sequence of State 1 (S₁)→State 2 (S₂)→State 1 (S₁). Additional replicates may be generated. For each replicate n, nₖ may correspond to the state at time k, and Kₙ may correspond to the time the Markov chain terminates.

As shown in FIG. 2C, and by reference number 206, computer 102 (e.g., processor set 114 of computer 102) may generate weights and probabilities for the state transitions (e.g., the Markov chain transitions between the data points). Computer 102 may update the transition probability data structure with associated probabilities for each Markov chain transition.

Computer 102 may generate the weights and probabilities for each replicate of the Markov chain. Computer 102 may set the initialization state of the estimation (C₁₁) to 1 at State 1 (S₁). Computer 102 may generate a weight for a transition from State 1 (S₁)→State 2 (S₂):

$$\frac{{a}_{12}}{{p}_{12}} .$$

Computer 102 may generate a weight for a transition from State 2 (S₂)→State 3 (S₃):

$$\frac{{a}_{23}}{{p}_{23}} .$$

Computer 102 may generate a weight for a transition from State 3 (S₃)→State 1 (S₁) (e.g., the return to the initialization state for the second replicate):

$$\frac{{a}_{31}}{{p}_{31}} .$$

The weights for the first regenerate cycle

$${a}_{1}^{11}$$

of the Markov chain may be represented as:

$${a}_{1}^{11} = \frac{{a}_{12}}{{p}_{12}} \frac{{a}_{23}}{{p}_{23}} \frac{{a}_{31}}{{p}_{31}} .$$

For the second regenerate cycle

$${a}_{2}^{11}$$

of the Markov chain, computer 102 may generate a weight for a transition from State 1 (S₁)→State 2 (S₂):

$$\frac{{a}_{12}}{{p}_{12}} .$$

Computer 102 may generate a weight for a transition from State 2 (S₂)→State 1 (S₁) (e.g., the return to the initialization state for a subsequent replicate):

$$\frac{{a}_{31}}{{p}_{31}} .$$

The weights for the second regenerate cycle

$${a}_{2}^{11}$$

of the Markov chain may be represented as:

$${a}_{2}^{11} = \frac{{a}_{12}}{{p}_{12}} \frac{{a}_{21}}{{p}_{21}} .$$

Computer 102 may generate weights for state transitions in additional regenerate cycle of the Markov chain in a similar manner.

As further shown in FIG. 2C, the weights for transitions of the Markov chain (C₁₁) may be represented as:

$$\begin{matrix}{C}^{11} = 1 + {a}_{1}^{11} + {a}_{1}^{11} {a}_{2}^{11} \\ or : \\ {C}^{11} = 1 + \frac{{a}_{12}}{{p}_{12}} \frac{{a}_{23}}{{p}_{23}} \frac{{a}_{31}}{{p}_{31}} + \frac{{a}_{12}}{{p}_{12}} \frac{{a}_{23}}{{p}_{23}} \frac{{a}_{31}}{{p}_{31}} \frac{{a}_{12}}{{p}_{12}} \frac{{a}_{21}}{{p}_{21}} .\end{matrix}$$

Since each such portion occurs independently of the other, the State 1(state i) may be a regeneration point for the Markov chain. Thus, the MCMC process has a regenerative structure that is based on a non-truncated Neumann series of the data structure:

$$\begin{matrix}{C}_{11} = 1 + {a}_{1}^{11} ( 1 + {a}_{2}^{11} + … ) \\ or : \\ {C}_{11} = 1 + \frac{{a}_{12}}{{p}_{12}} \frac{{a}_{23}}{{p}_{23}} \frac{{a}_{31}}{{p}_{31}} ( 1 + \frac{{a}_{12}}{{p}_{12}} \frac{{a}_{21}}{{p}_{21}} + … ) .\end{matrix}$$

Computer 102 may use the regenerative structure to define an initial state variable of

$$\begin{matrix}{T}_{0}^{ii} = 0 \\ where : \\ {T}_{k + 1}^{ii} = inf \{ t > {T}_{k}^{i i} \vert X ( t ) = i \} .\end{matrix}$$

The variable

$${T}_{k + 1}^{ii}$$

may correspond to the (k+1)-th return to the regeneration point (state i). Computer 102 may determine:

$${W}_{{T}_{k + 1}^{ii}} = {W}_{{T}_{k}^{ii}} \cdot {α}_{n}^{ii}$$

Where, based on the regenerativity of the Markov chain X, the scalars

$${α}_{n}^{ii}$$

may be random variables counting the increment of Wₖ between the

$${T}_{k}^{ii} and {T}_{k + 1}^{k} .$$

Computer 102 may determine:

$${Z}_{ii} := {W}_{0} {{\sum }^{∞}}_{n = 0} {{\prod }^{n}}_{k = 1} {α}_{k}^{ii}$$

which may satisfy a stochastic fixed point structure:

$${Z}_{ii} = {W}_{0} + {α}_{ii} {Z}_{ii}$$

where αᵢᵢ and Zᵢᵢ may be independent, αᵢᵢ corresponds to the distribution of

$${α}_{n}^{ii} ,$$

(n>0), and Zᵢᵢ corresponds to the distribution of

$${\sum }_{n = 0}^{∞} {W}_{{T}_{n}^{ii}} .$$

As shown in FIG. 2D, and by reference number 208, computer 102 (e.g., processor set 114 of computer 102) may determine an estimator for a precision data structure (e.g., an approximated inverse data structure) of the data structure (or of the covariance data structure). Computer 102 may determine the precision data structure using the regenerative structure of the MCMC process.

To determine the estimator, computer 102 may generate, maintain, and store a plurality of data structures. For example, computer 102 may generate, maintain, and store a current weight data structure (e.g., a matrix structure Λ), a cumulative weight data structure (e.g., a matrix structure Σ), and a regenerative cycle count data structure (e.g., a matrix structure Γ). In some implementations, computer 102 may also update the probability data structure (e.g., the matrix structure P) with the generated probabilities for the state transitions in the Markov chain. At the start of the MCMC process, the current weight data structure, the cumulative weight data structure, and the regenerative cycle count data structure may each be initialized to 0.

The current weight data structure may be a d×d matrix structure that may include data points representing the weights for the current regenerative cycle of the regenerative structure of the MCMC process. The cumulative weight data structure may be a d×d matrix structure that may include data points representing the weights for the all the accumulated weights from current regenerative cycle and previous weights of the regenerative structure of the MCMC process. The regenerative cycle count data structure may be a d×d matrix structure that may include data points representing the count or quantity of regeneration cycles that computer 102 has executed so far in the MCMC process.

For a transition from state i (e.g., a first data point in the data structure) to state j (e.g., a second data point in the data structure that computer 102 selects according to a probability pᵢⱼ in the transition probability data structure), computer 102 may update the current weight data structure by updating the i-th row of the current weight data structure that is associated with the state i. Computer 102 may then update the current weight data structure based on the weight and the probability associated with the transition from state i to state j:

$$Λ = Λ ⨯ \frac{{a}_{ij}}{{p}_{ij}} .$$

For the transition from state i to state j, computer 102 may update the cumulative weight data structure by updating the j-th column of the cumulative weight data structure that is associated with the state j. This may include transferring a column of the current weight data structure that is associated with state j to the j-th column of the cumulative weight data structure.

Computer 102 may reset the j-th column of the current weight data structure to 0 for the next state transition. Computer 102 may also transfer the state j to the state i for the next state transition.

Computer 102 may update the current weight data structure, the cumulative weight data structure, and the regenerative cycle count data structure for a plurality of regeneration cycles described above in parallel. For example, computer 102 may execute the plurality of regenerative cycles concurrently in parallel (e.g., on different processors of processor set 114), and may update the current weight data structure, the cumulative weight data structure, and the regenerative cycle count data structure for a plurality of regeneration cycles accordingly.

As shown in FIG. 2D, computer 102 may determine the estimator [symbol] based on the current weight data structure and the cumulative weight data structure:

$$\text{?} = \{ \begin{matrix}\frac{1}{1 - \frac{{Σ}_{jj}}{{Γ}_{jj}}} if i = j \\ \frac{{Σ}_{ij}}{{Λ}_{ij}} \frac{1}{1 - \frac{{Σ}_{jj}}{{Γ}_{jj}}} if i = j\end{matrix} .$$

As shown in FIG. 2E, and by reference number 210, computer 102 (e.g., processor set 114 of computer 102) may generate a precision data structure based on the estimator. The precision data structure may be an approximated inverse of the data structure (e.g., an inverse matrix A⁻¹) that is determined using the estimator.

As shown in FIG. 2F, and by reference number 212, computer 102 (e.g., processor set 114 of computer 102) may determine, based on the precision data structure, a partial correlation between two or more data points in the data structure (or in the covariance data structure). The partial correlation between two data points may be indicated an intersection of a row and a column in the data structure. The partial correlation pᵢⱼ between data points i and j may be a correlation after removing the linear effects of all other data points in the data structure. Computer 102 may determine the partial correlation pᵢⱼ between data points i and j based on the precision data structure (e.g., the approximated inverse of the data structure) as:

$${p}_{ij} = - \frac{{A}_{ij}^{- 1}}{\sqrt{{A}_{ii}^{- 1} \cdot {A}_{jj}^{- 1}}} ,$$

where

$${A}_{ij}^{- 1}$$

corresponds to a direct relationship between data points i and j (e.g.,

$${A}_{ij}^{- 1}$$

is the element in the i-th row and the j-th column of the precision data structure A⁻¹ representing the partial covariance between data points i and j), and

$$\sqrt{{A}_{ii}^{- 1} \cdot {A}_{jj}^{- 1}}$$

normalizes the correlation.

$${A}_{ii}^{- 1}$$

and

$${A}_{jj}^{- 1}$$

are the diagonal elements of the precision data structure A⁻¹, representing the precision (the inverse of variance) of the data points i and j, respectively.

FIGS. 2A-2F are provided as an example. Other examples may differ from what is described with regard to FIGS. 2A-2F.

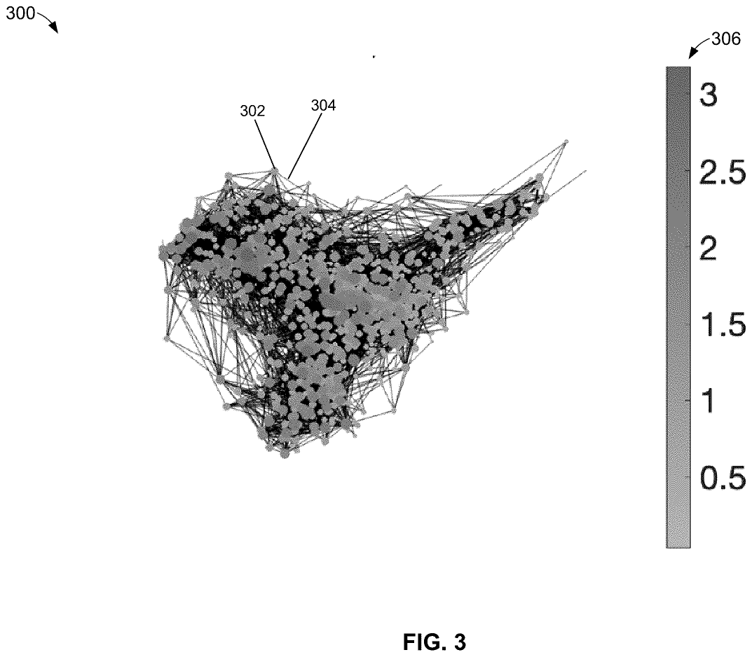

FIG. 3 is a diagram of an example implementation 300 of determining connections between network entities in a computer network based on an inverse data structure approximation that as determined using a regenerative MCMC technique described herein.

A plurality of network entities 302 may communicate over a computer network, such as WAN 104. Such network entities 302 may include computer 102, EUD 106, remote server 108, public cloud 110, private cloud 112, and/or one or more devices included therein, among other examples.

In some implementations, each network entity 302 is associated with a user of the network entity 302. Network entities 302 may each be a data point in a data structure (e.g., a matrix structure), and communications between network entities 302 (e.g., emails, texts, messages, forum posts) may be used to infer or identify connections 304 between two network entities 302. Connections 304 may also be represented as data points in the data set.

The data set inversion techniques described in connection FIGS. 2A-2F, and elsewhere herein, may be used to infer or determine a level of influence 306 of network entities 302 based on connections 304 between network entities 302. For example, computer 102 may determine, using a regenerative structure of an MCMC process, an estimator for an approximated inverse of the data structure containing the data points representing network entities 302 and the connections 304. The regenerative structure of the MCMC process may be based on a non-truncated Neumann series of the data structure. Computer 102 may generate a precision data structure based on the estimator, which may correspond to the approximated inverse of the data structure. Computer 102 may determine, based on the precision data structure, a partial correlation between two or more data points (e.g., two or more network entities 302) in the data structure. The partial correlations can be used to determine the level of influence 306 that each network entity 302 has on other network entities 302.

Determining the level of influence 306 of a network entity 302 may be a Katz centrality process in which direct and indirect connections 304 between network entities 302 are considered. A data structure (referred to as an adjacency matrix) representing the connections 304 between network entities 302, where an adjacency matrix element Aᵢⱼ of the data structure corresponds to a connection 304 between a network entity i and a network entity j.

Computer 102 may determine the Katz centrality C as:

$$C = {( I - α A )}^{- 1} 1$$

Where I is the identity data structure (e.g., the identity matrix) of the data structure (e.g., of the adjacency matrix A), and α is a decay factor that is used to reduce the influence of indirect connections. Thus, the Katz centrality is based on the inverse of the data structure (e.g., of the adjacency matrix A), which computer 102 may approximate using the data set inversion techniques described in connection FIGS. 2A-2F and elsewhere herein.

FIG. 3 is provided as an example. Other examples may differ from what is described with regard to FIG. 3.

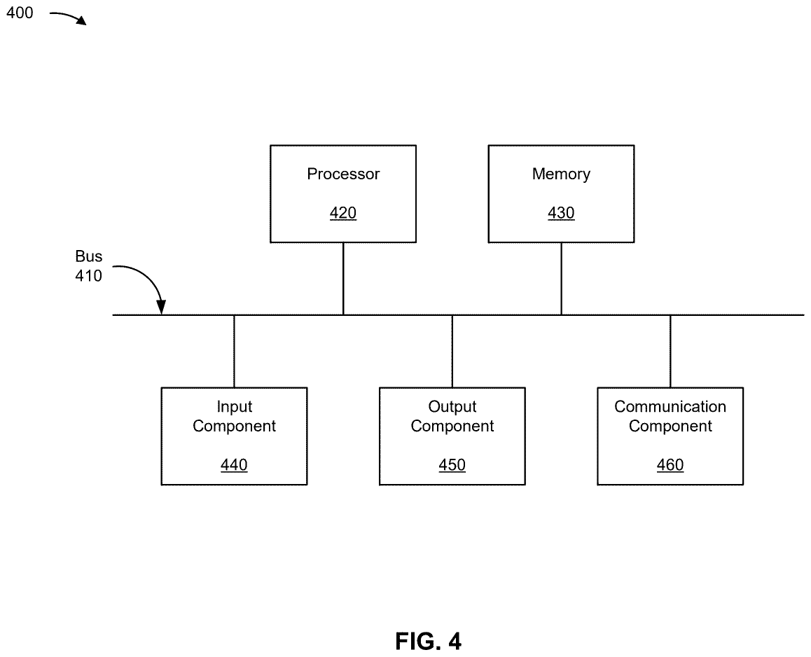

FIG. 4 is a diagram of example components of a device 400 associated with computing inverse data structure approximations using a regenerative Markov chain Monte Carlo technique. The device 400 may correspond to one or more devices in computing environment 100 of FIG. 1, such as computer 102, EUD 106, remote server 108, public cloud 110, and/or private cloud 112, among other examples. In some implementations, one or more devices in computing environment 100 of FIG. 1, such as computer 102, EUD 106, remote server 108, public cloud 110, and/or private cloud 112, among other examples, may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

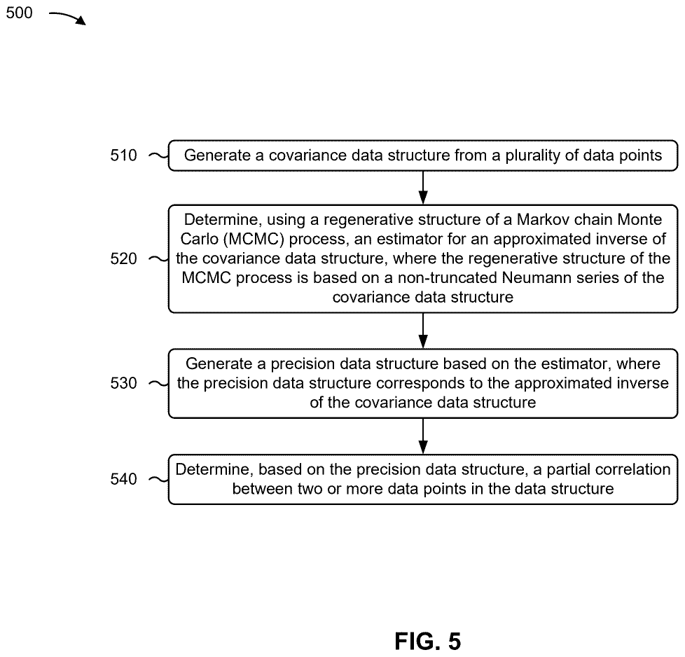

FIG. 5 is a flowchart of an example process 500 associated with computing inverse data structure approximations using a regenerative MCMC technique. In some implementations, one or more process blocks of FIG. 5 are performed by a computer (e.g., computer 102). In some implementations, one or more process blocks of FIG. 5 are performed by another device or a group of devices separate from or including the computer 102, such as an EUD (e.g., EUD 106), a remote server (e.g., a remote server 108), a public cloud (e.g., a public cloud 110), a private cloud (e.g., a private cloud 112), and/or a device (e.g., a device 400), among other examples. Additionally, or alternatively, one or more process blocks of FIG. 5 may be performed by one or more components of device 400, such as processor 420, memory 430, input component 440, output component 450, and/or communication component 460. In some implementations, computer 102 may execute inverse data set approximation code 150 to perform one or more of the operations described in the example process 500.

As further shown in FIG. 5, process 500 may include generating a covariance data structure from a plurality of data points (block 510). For example, computer 102 may generate a covariance data structure from a plurality of data points, as described above.

As further shown in FIG. 5, process 500 may include determining, using a regenerative structure of an MCMC process, an estimator for an approximated inverse of the covariance data structure, where the regenerative structure of the MCMC process is based on a non-truncated Neumann series of the covariance data structure (block 520). For example, computer 102 may determine, using a regenerative structure of an MCMC process, an estimator for an approximated inverse of the covariance data structure, as described above. In some implementations, the regenerative structure of the MCMC process is based on a non-truncated Neumann series of the covariance data structure.

As further shown in FIG. 5, process 500 may include generating a precision data structure based on the estimator, where the precision data structure corresponds to the approximated inverse of the covariance data structure (block 530). For example, computer 102 may generate a precision data structure based on the estimator, as described above. In some implementations, the precision data structure corresponds to the approximated inverse of the covariance data structure.

As further shown in FIG. 5, process 500 may include determining a partial correlation between two or more data points in the covariance data structure (block 540). For example, computer 102 may determine a partial correlation between two or more data points in the covariance data structure, as described above.

Process 500 may include additional implementations, such as any single implementation or any combination of implementations described below and/or in connection with one or more other processes described elsewhere herein.

In a first implementation, the determining the estimator for the covariance data structure includes determining the estimator for the covariance data structure based on executing a plurality of regenerative cycles of the regenerative structure of the MCMC process on the covariance data structure.

In a second implementation, alone or in combination with the first implementation, the determining the estimator for the covariance data structure based on executing the plurality of regenerative cycles includes executing the plurality of regenerative cycles concurrently in parallel.

In a third implementation, alone or in combination with the first and/or second implementations, the executing the plurality of regenerative cycles concurrently in parallel includes executing the plurality of regenerative cycles concurrently in parallel on different processors of the processor set.

In a fourth implementation, alone or in combination with one or more of the first and third implementations, the regenerative structure includes historical weights for historical transitions of transitions between states in the covariance data structure, and additional weights for additional transitions between the states in the covariance data structure.

In a fifth implementation, alone or in combination with one or more of the first through fourth implementations, process 500 includes generating probabilities associated with transitions between states in a sequence of states of the covariance data structure, and storing the probabilities in a probability data structure.

In a sixth implementation, alone or in combination with one or more of the first through fifth implementations, generating the covariance data structure includes generating the covariance data structure based on an identity data structure associated with the covariance data structure.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

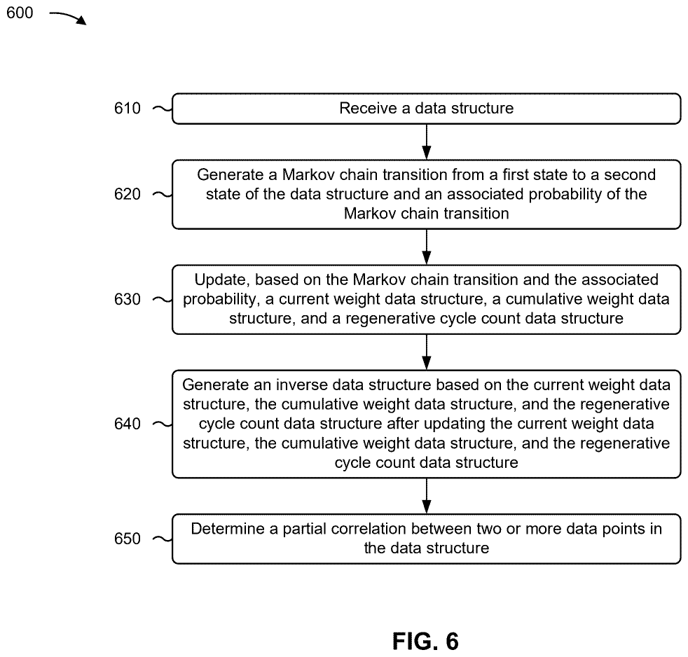

FIG. 6 is a flowchart of an example process 600 associated with computing inverse data structure approximations using a regenerative MCMC technique. In some implementations, one or more process blocks of FIG. 5 are performed by a computer (e.g., computer 102). In some implementations, one or more process blocks of FIG. 5 are performed by another device or a group of devices separate from or including the computer 102, such as an EUD (e.g., EUD 106), a remote server (e.g., a remote server 108), a public cloud (e.g., a public cloud 110), a private cloud (e.g., a private cloud 112), and/or a device (e.g., a device 400), among other examples. Additionally, or alternatively, one or more process blocks of FIG. 5 may be performed by one or more components of device 400, such as processor 420, memory 430, input component 440, output component 450, and/or communication component 460. In some implementations, computer 102 may execute inverse data set approximation code 150 to perform one or more of the operations described in the example process 600.

As shown in FIG. 6, process 600 may include receiving a data structure (block 610). For example, computer 102 may receive a data structure, as described above.

As further shown in FIG. 6, process 600 may include generating a Markov chain transition from a first state to a second state of the data structure and an associated probability of the Markov chain transition (block 620). For example, computer 102 may generate a Markov chain transition from a first state to a second state of the data structure and an associated probability of the Markov chain transition, as described above.

As further shown in FIG. 6, process 600 may include updating, based on the Markov chain transition and the associated probability, a current weight data structure, a cumulative weight data structure, and a regenerative cycle count data structure (block 630). For example, computer 102 may update, based on the Markov chain transition and the associated probability, a current weight data structure, a cumulative weight data structure, and a regenerative cycle count data structure, as described above.

As further shown in FIG. 6, process 600 may include generating an inverse data structure based on the current weight data structure, the cumulative weight data structure, and the regenerative cycle count data structure after updating the current weight data structure, the cumulative weight data structure, and the regenerative cycle count data structure (block 640). For example, computer 102 may generate an inverse data structure based on the current weight data structure, the cumulative weight data structure, and the regenerative cycle count data structure after updating the current weight data structure, the cumulative weight data structure, and the regenerative cycle count data structure, as described above.

As further shown in FIG. 6, process 600 may include determining a partial correlation between two or more data points in the data structure (block 650). For example, computer 102 may determine a partial correlation between two or more data points in the data structure, as described above.

Process 600 may include additional implementations, such as any single implementation or any combination of implementations described below and/or in connection with one or more other processes described elsewhere herein.

In a first implementation, process 600 includes generating the Markov chain transition based on a transition data structure associated with the data structure.

In a second implementation, alone or in combination with the first implementation, the updating the current weight data structure includes updating a row of the current weight data structure that is associated with the first state.

In a third implementation, alone or in combination with the first and/or second implementations, process 600 includes generating a weight associated with the Markov chain transition from the first state to the second state, where updating the current weight data structure includes updating the current weight data structure based on the weight associated with the Markov chain transition from the first state to the second state.

In a fourth implementation, alone or in combination with one or more of the first through third implementations, the updating the cumulative weight data structure includes updating a column of the cumulative weight data structure that is associated with the second state.

In a fifth implementation, alone or in combination with one or more of the first through fourth implementations, the updating the column of the cumulative weight data structure that is associated with the second state includes transferring a column of the current weight data structure that is associated with the second state to the column of the cumulative weight data structure that is associated with the second state.

In a sixth implementation, alone or in combination with one or more of the first through fifth implementations, the updating the regenerative cycle count data structure includes updating a column of the regenerative cycle count data structure that is associated with the second state.

In a seventh implementation, alone or in combination with one or more of the first sixth third implementations, the determining the partial correlation between two or more data points in the data structure includes determining a level of influence between the two or more data points in the data structure.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

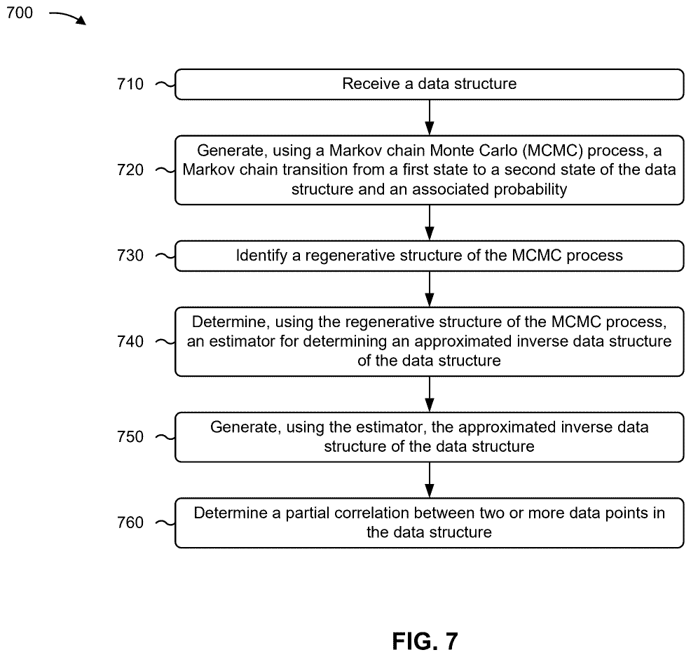

FIG. 7 is a flowchart of an example process 700 associated with computing inverse data structure approximations using a regenerative MCMC technique. In some implementations, one or more process blocks of FIG. 5 are performed by a computer (e.g., computer 102). In some implementations, one or more process blocks of FIG. 5 are performed by another device or a group of devices separate from or including the computer 102, such as an EUD (e.g., EUD 106), a remote server (e.g., a remote server 108), a public cloud (e.g., a public cloud 110), a private cloud (e.g., a private cloud 112), and/or a device (e.g., a device 400), among other examples. Additionally, or alternatively, one or more process blocks of FIG. 5 may be performed by one or more components of device 400, such as processor 420, memory 430, input component 440, output component 450, and/or communication component 460. In some implementations, computer 102 may execute inverse data set approximation code 150 to perform one or more of the operations described in the example process 700.

As shown in FIG. 7, process 700 may include receiving a data structure (block 710). For example, the computer 102 may receive a data structure, as described above.

As further shown in FIG. 7, process 700 may include generating, using an MCMC process, a Markov chain transition from a first state to a second state of the data structure and an associated probability (block 720). For example, computer 102 may generate, using an MCMC process, a Markov chain transition from a first state to a second state of the data structure and an associated probability, as described above.

As further shown in FIG. 7, process 700 may include identifying a regenerative structure of the MCMC process (block 730). For example, the computer 102 may identify a regenerative structure of the MCMC process, as described above.

As further shown in FIG. 7, process 700 may include determining, using the regenerative structure of the MCMC process, an estimator for determining an approximated inverse data structure of the data structure (block 740). For example, computer 102 may determine, using the regenerative structure of the MCMC process, an estimator for determining an approximated inverse data structure of the data structure, as described above.

As further shown in FIG. 7, process 700 may include generating, using the estimator, the approximated inverse data structure of the data structure (block 750). For example, computer 102 may generate, using the estimator, the approximated inverse data structure of the data structure, as described above.

As further shown in FIG. 7, process 700 may include determining a partial correlation between two or more data points in the data structure (block 760). For example, computer 102 may determine a partial correlation between two or more data points in the data structure, as described above.

Process 700 may include additional implementations, such as any single implementation or any combination of implementations described below and/or in connection with one or more other processes described elsewhere herein.

In a first implementation, the estimator is a single-parameter estimator for determining the approximated inverse data structure of the data structure.

In a second implementation, alone or in combination with the first implementation, the estimator is specific to a Stochastic fixed point structure.

In a third implementation, alone or in combination with the first and/or second implementation, process 700 includes using the partial correlation between the two or more data points in the data structure to compute a centrality measure of a node in a network.

In a fourth implementation, alone or in combination with one or more of the first through third implementations, process 700 includes using the partial correlation between the two or more data points in the data structure to identify influential nodes or connections between nodes in a network.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method, comprising:
generating, by a processor set, a covariance data structure from a plurality of data points;
determining, by the processor set and using a regenerative structure of a Markov chain Monte Carlo (MCMC) process, an estimator for an approximated inverse of the covariance data structure,
wherein the regenerative structure of the MCMC process is based on a non-truncated Neumann series of the covariance data structure;
generating, by the processor set, a precision data structure based on the estimator,
wherein the precision data structure corresponds to the approximated inverse of the covariance data structure; and
determining, by the processor set based on the precision data structure, a partial correlation between two or more data points in the covariance data structure.

2. The computer-implemented method of claim 1, wherein the determining the estimator for the covariance data structure comprises:
determining the estimator for the covariance data structure based on executing a plurality of regenerative cycles of the regenerative structure of the MCMC process on the covariance data structure.

3. The computer-implemented method of claim 2, wherein the determining the estimator for the covariance data structure based on executing the plurality of regenerative cycles comprises:
executing the plurality of regenerative cycles concurrently in parallel.

4. The computer-implemented method of claim 3, wherein the executing the plurality of regenerative cycles concurrently in parallel comprises:
executing the plurality of regenerative cycles concurrently in parallel on different processors of the processor set.

5. The computer-implemented method of claim 1, wherein the regenerative structure comprises:
historical weights for historical transitions between states in the covariance data structure; and
additional weights for additional transitions of the transitions between the states in the covariance data structure.

6. The computer-implemented method of claim 1, further comprising:
generating probabilities associated with transitions between states in a sequence of states of the covariance data structure; and
storing the probabilities in a probability data structure.

7. The computer-implemented method of claim 1, wherein the generating the covariance data structure comprises:
generating the covariance data structure based on an identity data structure associated with the covariance data structure.

8. A computer system, comprising:
a processor set;
one or more computer-readable storage media; and
program instructions stored on the one or more computer-readable storage media to cause the processor set to perform operations comprising:
receiving a data structure;
generating a Markov chain transition from a first state to a second state of the data structure and an associated probability of the Markov chain transition;
updating, based on the Markov chain transition and the associated probability, a current weight data structure, a cumulative weight data structure, and a regenerative cycle count data structure;
generating an inverse data structure based on the current weight data structure, the cumulative weight data structure, and the regenerative cycle count data structure after updating the current weight data structure, the cumulative weight data structure, and the regenerative cycle count data structure; and
determining a partial correlation between two or more data points in the data structure.

9. The computer system of claim 8, wherein the operations further comprise:
generating the Markov chain transition based on a transition data structure associated with the data structure.

10. The computer system of claim 8, wherein the updating the current weight data structure comprises:
updating a row of the current weight data structure that is associated with the first state.

11. The computer system of claim 8, wherein the operations further comprise:
generating a weight associated with the Markov chain transition from the first state to the second state,
wherein the updating the current weight data structure comprises:
updating the current weight data structure based on the weight associated with the Markov chain transition from the first state to the second state.

12. The computer system of claim 8, wherein the updating the cumulative weight data structure comprises:
updating a column of the cumulative weight data structure that is associated with the second state.

13. The computer system of claim 12, wherein the updating the column of the cumulative weight data structure that is associated with the second state comprises:
transferring a column of the current weight data structure that is associated with the second state to the column of the cumulative weight data structure that is associated with the second state.

14. The computer system of claim 8, wherein the updating the regenerative cycle count data structure comprises:
updating a column of the regenerative cycle count data structure that is associated with the second state.

15. The computer system of claim 8, wherein the determining the partial correlation between two or more data points in the data structure comprises:
determining a level of influence between the two or more data points in the data structure.

16. A computer program product, comprising:
one or more computer-readable storage media; and
program instructions stored on the one or more computer-readable storage media to perform operations comprising:
receiving a data structure;
generating, using a Markov chain Monte Carlo (MCMC) process, a Markov chain transition from a first state to a second state of the data structure and an associated probability;
identifying a regenerative structure of the MCMC process;
determining, using the regenerative structure of the MCMC process, an estimator for determining an approximated inverse data structure of the data structure;
generating, using the estimator, the approximated inverse data structure of the data structure; and
determining a partial correlation between two or more data points in the data structure.

17. The computer program product of claim 16, wherein the estimator is a single-parameter estimator for determining the approximated inverse data structure of the data structure.

18. The computer program product of claim 16, wherein the estimator is specific to a Stochastic fixed point structure.

19. The computer program product of claim 16, wherein the operations further comprise:
using the partial correlation between the two or more data points in the data structure to compute a centrality measure of a node in a network.

20. The computer program product of claim 16, wherein the operations further comprise:
using the partial correlation between the two or more data points in the data structure to identify influential nodes or connections between nodes in a network.
